(19) United States
(12) Patent Application Publication
(10) Pub. No.: US 2006/0206490 A1
(43) Pub. Date: Sep. 14, 2006

(54) Computerized legal case management system incorporating reconciliation feature

(76) Inventor: Izzy Schiller, Riverdale, NY (US)

Correspondence Address: BRYAN CAVE LLP, 211 NORTH BROADWAY, SUITE 3600, ST. LOUIS, MO, 63102-2750, US

(21) Appl. No.: 11/077,851

(22) Filed: Mar. 11, 2005

(51) Int. Cl. G06F 17/30

(52) U.S. Cl. 707/10

(57) ABSTRACT

A method for docketing and reporting activities related to a legal case by first establishing a database in a computer memory for storing case data comprised of a plurality of docket records associated with the legal case. The database is then populated with one or more docket records. A court sourced alert associated with the legal case is received via a communications network and loaded into the database. A docket report listing and identifying the at least one docket record and the court sourced alert is generated and displayed to a subscriber or user. The user may then reconcile the court sourced alert with the docket record and the displayed docket report listing is modified to indicate that the court sourced alert has been reconciled with the docket record.

### FIELD OF THE INVENTION

This invention generally relates to the field of docket tracking and scheduling for the legal profession and, more specifically, to a computerized legal case management system.

### BACKGROUND OF THE INVENTION

Attorneys and other members of the legal profession are required to take certain actions in accordance with deadlines established by various statutes and court rules. Members of the legal profession place great emphasis on meeting these deadlines as the failure to adhere to such deadlines can have significant consequences for the attorneys' clients. Rather than relying on memory or the use of a personal calendar, many professionals within the legal industry use some form of a docketing system, often a computerized docketing system to track and notify legal professionals of the upcoming deadlines. In addition to tracking deadlines, conventional computerized docketing systems record all activities occurring for a number of cases. The accuracy and use of a computerized docketing system is of paramount importance to practicing litigation attorneys.

There are many commercially available case management systems, many of which provide for the docketing of events, manual recording of future tasks and deadlines, and notification to users regarding upcoming events. One such commercially available system is known as the MA-3000® system, associated with the New York Law Journal. This system includes both a basic docketing system and a search of a daily industry newspaper.

There also exist service organizations that electronically or manually monitor pending court cases and provide notification, for example, via electronic mail, of activity recorded by the court for certain identified (or “watched”) cases. When information regarding a watched case becomes available, an alert is generated and distributed to interested subscribers. In addition, some existing service organizations attempt to locate any court documents, for example, a court decision or order, and deliver a copy of the document to the subscribers, along with the alert. As an alert may be generated in advance of the availability of the court document, there may be a period of time between the delivery of the alert and the delivery of the actual document associated with such alert. It is common for both alerts and associated court documents to be delivered to subscribers in electronic form via an electronic mail message. It is also common for these existing systems to provide additional information related to the operation of court systems, such as a calendar for one or more judicial officials or information on court rules and procedures. The electronic mail alerts from the service organization may interface with the above-described case management system or with a software module developed by the service organization and maintained on a user's computer system. In addition, the service organizations may host a web site that may be used by law firms, law departments, and the like to retrieve case information. The website may also provide court rules, forms and other similar information. One such service organization is CourtAlert.com, Inc.

In a typical large law firm or law department, a managing clerk or paralegal is responsible for managing and tracking the docket reports for a large number of legal cases. It is typical for this clerk to receive information from a variety of sources, such as other professionals assigned to the case, and the service organizations described above, enter the information in a computerized docketing system, track important due dates, and advise various team members regarding the status of the cases and upcoming due dates. This clerk typically uses the above-described computerized legal case management system. For example, the clerk may receive an alert from CourtAlert® and manually enter or cut-and-paste the information from the alert into the case management system.

It is difficult using the available docketing systems to readily integrate information together—for example, information recently provided by a service organization with information previously contained in the docketing system. Furthermore, in addition to accurately tracking and reporting important due dates, it is important that the case management system not over report activities, i.e., by ensuring that a single deadline or event is not needlessly reported to case members multiple times.

Thus, there is a strong need for a system that allows a user to integrate and reconcile court sourced information, such as derived from alerts received from service organizations, with pre-existing docket records within the computerized docketing system. Preferably, such a system would be integrated into a computerized docketing system that permits users to reconcile information, update or create new docket records, create or modify diary entries, and apprise case team members with respect to the updated information.

### SUMMARY OF THE INVENTION

In one aspect of the invention, a method is provided for docketing and reporting activities related to a legal case by first establishing a web-enabled database in a computer memory for storing case data comprised of a plurality of docket records associated with the legal case. The database is then populated with one or more docket records. A court sourced alert associated with the legal case is received via a communications network and loaded into the database. A docket report listing and identifying the at least one docket record and the court sourced alert is generated and displayed to a subscriber or user. The user may then reconcile the court sourced alert with the docket record and the displayed docket report listing is modified to indicate that the court sourced alert has been reconciled with the docket record.

The docket record may be updated with information contained in the court sourced alert and users or subscribers of the system may be notified of the updated docket record. In addition, a diary entry based on the information contained in the updated docket record may be generated and periodically distributed to users. A docket report may indicate those court sourced alerts that remain unreconciled with any docket records. The method may be implemented as a computer program executing on one or more processors.

### BRIEF DESCRIPTION OF THE DRAWINGS

These and other features, aspects and advantages of the invention will become more fully apparent from the following detailed description, appended claims, and accompanying drawings, wherein each of the drawings illustrates a feature of the case management system in accordance with an exemplary embodiment of the present invention, and wherein:

FIG. 1 illustrates a case management system in accordance with an exemplary embodiment of the present invention;

FIG. 2 is a screen capture of an initial page for the case management system;

FIGS. 3-6 are a series of screen captures illustrating the process to add a new case to the case management system;

FIGS. 7-10 are a set of screen captures of pages of the case management system illustrating the process for creating a new docket record;

FIG. 11 is a screen capture illustrating the process of adding a diary entry using the case management system;

FIGS. 12-15 are a set of screen captures of pages of the case management system illustrating the reconciliation feature of the present invention;

FIGS. 16-17 are screen captures of the case management system illustrating the inquiry feature; and

FIG. 18 is a screen capture of a page in the case management system providing proposed diary selections.

These drawings are provided for illustrative purposes only and should not be used to unduly limit the scope of the present invention.

### DESCRIPTION

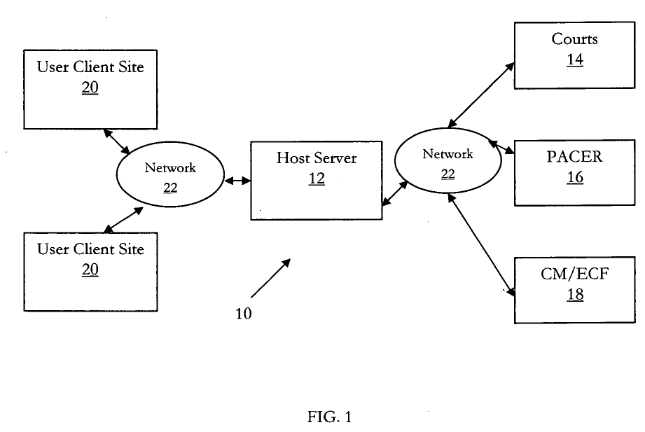

A computerized legal case management system 10 in accordance with one embodiment of the present invention is illustrated in FIG. 1. The case management system 10 includes a host server 12 having one or more docketing databases for storing case data that includes docket records associated with one or more legal cases. The docketing database is populated with information available from at least four entities: information obtained from courts 14 via an alert system, information available over the PACER system 16, information available through the CM/ECF system 18, and information provided by subscribers at user client sites 20, which may include a conventional desktop computer system. The PACER and CM/ECF systems are described below. Information may be exchanged with the docketing database associated with the host server 12 via a conventional computer network 22 or the Internet. The user client sites 20 may include thick client users, such as a PC connected to the network for the managing clerk or thin client users via local or remote inquiry. The docketing database may be replicated or partially stored on one or more of the client sites 20.

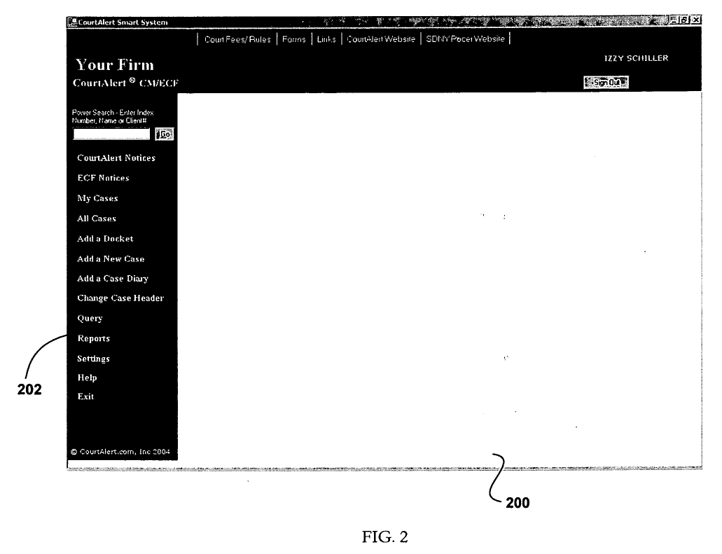

FIG. 2 is a screen capture of an initial page 200 for the case management system 10 as accessed at a user client site 20. The case management system 10 may be accessed at a client site 20 through a network. Alternatively, the system 10 may be partially or wholly installed on a computer system at a client site 20. The initial page 200 controls access to the case management system 10 in a conventional manner, for example through the use of login identifiers and passwords. From the initial page 200, a user at a client site 20 can access and manipulate the information stored in the one or more docketing databases associated with the case management system 10. Interaction with the case management system 10 and its databases may be implemented in a conventional manner such as using display objects, i.e., buttons or icons displayed on the side bar 202 of the initial page 200. As illustrated in FIG. 2, these choices may include options to access and manipulate user entered dockets, court sourced alerts originating with the PACER system or the CM/ECF system, and court sourced alerts derived from a service organization, such as CourtAlert.® The initial page 200 may include a number of display options for adding or manipulating the data within or associated with the docketing databases, including adding cases, docket entries, and diary entries, as well as formulating queries and reports. Some of these options are relatively common on conventional computer-based docketing systems and will not be described in detail as their implementation and use are already known to those skilled in the art. As will be described below, the display options depicted in side bar 202 are used to activate certain features of the system.

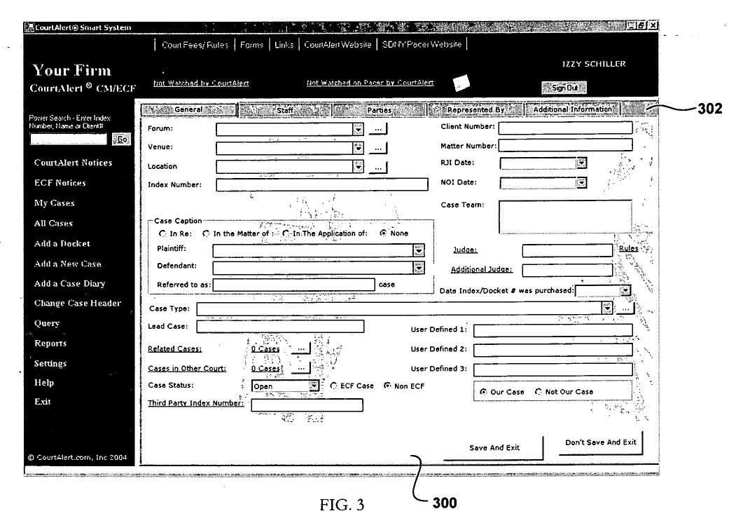

FIGS. 3-6 are a series of screen captures illustrating user interfaces to the process to add a new case to the case management system 10. Each screen capture corresponds to a display generated by the case management system 10 and presented on a computer at a client's site 20. The displays include conventional icons which may be selected or activated by a point and click operation or other similar means to direct the case management system to a desired operation. The new case screen 300 as depicted in FIG. 3 may be accessed by selecting the Add a New Case option 202 from the initial login screen or another appropriate screen.

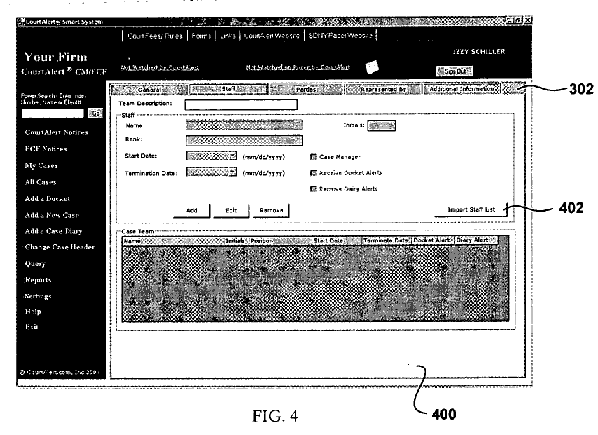

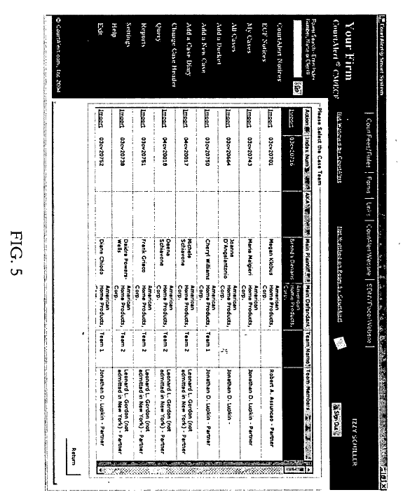

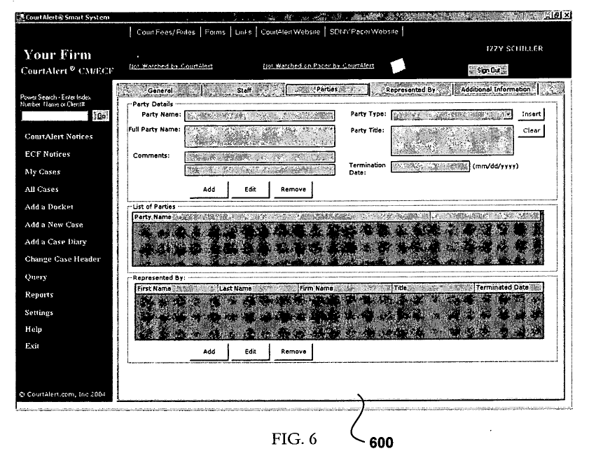

As illustrated in FIG. 3, once at the new case screen 300, selection of one of the display objects along top bar 302 presented at the top of the screen, allows the user to enter case records, for example, certain information relevant to the docketing of the legal case including the court venue, location and judge assignment, a court generated index or case number, identification of the parties and type, identification of the type of case and related case information, a client and matter tracking number, a list of team members, and other relevant information. The information contained in the case records may be entered into the fields illustrated through various operations of the case management system. For example, the information may be partially supplied through the use of drop-down menu selections or copied from prior entries. All of this information keyed or copied in by the user is stored in the searchable docketing database. FIG. 3 depicts a screen used to enter certain case related information into the docketing database to build a docket record. As illustrated in FIG. 4, selection of the staff display object within top bar 302 pulls up a staff screen 400, which allows the user or subscriber to include information regarding the individual legal professionals assigned to the case. Again, this information may be keyed in the available windows, selected from pull-down menus, or copied from other sources as in a conventional web-based application. The staff screen 400 may include an option 402 to import a staff list from an existing case within the database. As illustrated in FIG. 5, selection of option 402 allows the user to select staff from previously defined cases: As illustrated in FIG. 6, selection of the parties display object from the top bar 302 pulls up a parties screen 600, which allows the user to enter information regarding the parties to the selected case and the law firms that represent each party.

The system also includes a process to add a case to a watch list. As discussed above, a watch list includes cases for which the user or subscriber requests that a service organization monitor and provide court sourced alerts containing information related to the status of the case—for example when pleadings are filed or when orders are issued by the court. The case identified is automatically added to the watch list of the appropriate service organization. From that point, the user or subscriber will automatically receive information related to the case via, for example, electronic mail notifications.

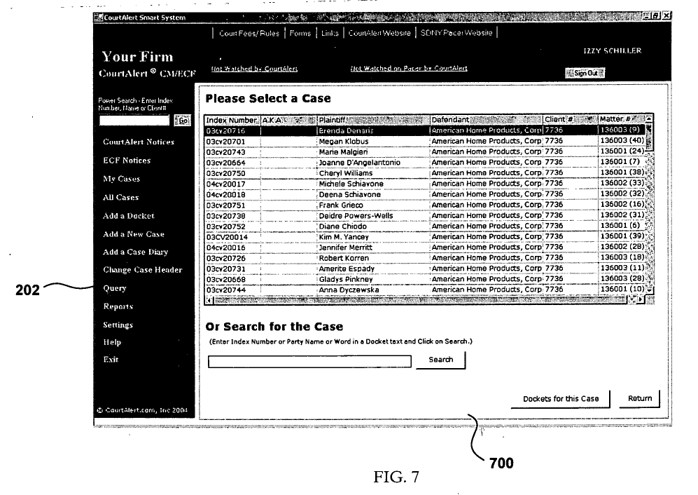

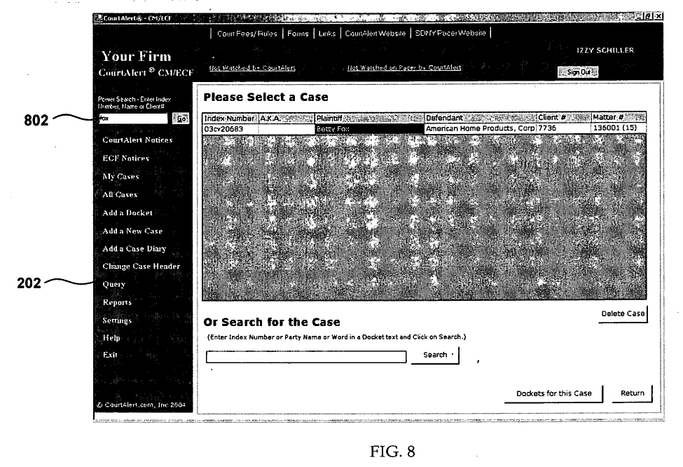

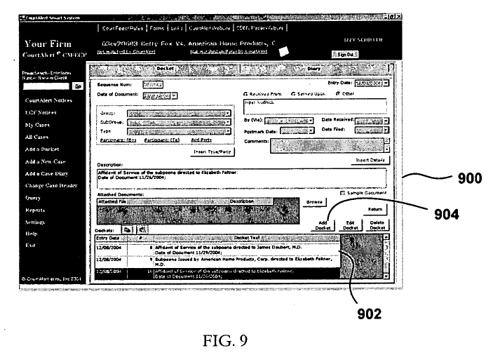

FIGS. 7-10 are a set of screen captures of pages of the case management system 10 illustrating the process for creating a new docket record or diary entry. This process may be invoked by selecting the “Add a Docket” display option from side bar 202. Selection of this option brings up a screen 700 as illustrated in FIG. 7, which shows a list of previously entered cases. The user can select one of the cases in order to create or update a docket record or a diary entry by using conventional selection methods such as double-clicking on one of the case entries using a computer mouse or by scrolling up/down to highlight one of the cases and then selecting the enter key. Alternatively, as illustrated in FIG. 8, the user can use the search window 802 to search by case name, court assigned index number, customer assigned client and matter number, or by specific words included in the docket entries. As illustrated in FIG. 9, selection of a case brings up a window in which the user may toggle between reviewing, creating and/or updating a docket record or a diary entry. In the example illustrated in FIG. 9, a docket record screen 900 is displayed to the user. As shown in FIG. 9, the user can select one of the docket entries at the bottom of the screen (in the area labeled 902) for modification or can create a new docket entry by completing the information in the windows displayed in the upper portion of the docket record screen 900 by using drop-down menus or by entering information manually. Some of this information may be provided to the user for selection via pull-down menus, or it may be copied from other docket records. As illustrated in FIG. 9, the information contained in a docket record may include those items depicted in FIG. 9 such as, for example, the description of the document, the date and sequence number of the record, how a document was received or transmitted, from or to whom the documents was received or sent, the date the document was received and filed, comments, and other relevant information. As is common on web-based applications, additional display objects for the user/subscriber to select are included such as add, edit, and delete functions.

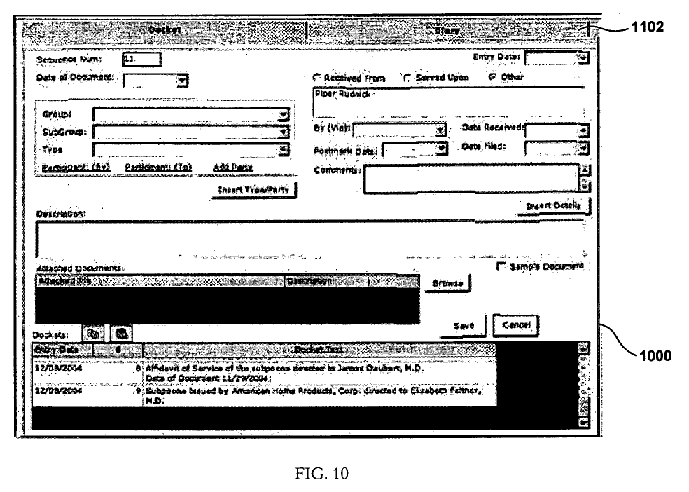

Selection of the Add Docket option 904 brings up a new docket screen 1000 as illustrated in FIG. 10. The system allows a user to enter in various data relating to the new docket record including the document date, the document type, the author, the party, the method of service, and other details or comments. The user may also attach a file to a docket record. The file, such as a pdf image file, text files, video or audio files, may be attached to a docket record using convention means such as using a browse function or through API with document management systems.

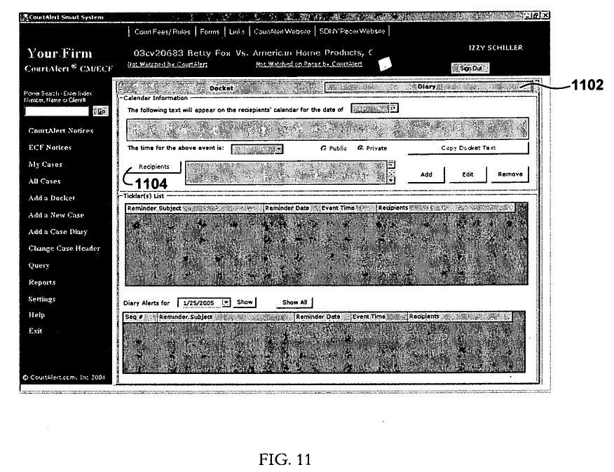

The case management system 10 also allows users or subscribers to include and distribute diary entries associated with a case. FIG. 11 is a screen capture illustrating the process of adding a diary entry using the case management system, which may be accessed from the diary display option 1102 located at the top of the screen. Using the case management system, a user can enter diary entries with future assignments and due dates. The system will then send the docket and due date reminders to other users working on the associated legal case. A diary entry may include a date, a task and a list of team members to receive the diary alert, such as through an electronic mail notification, and other related information. A list of possible recipients for the diary entry as illustrated in FIG. 11 may be accessed by clicking on the Recipients option 1104 on FIG. 11 for a diary related to a docket record.

Information stored within the docketing database may also be obtained from a court sourced alert generated by a service organization (e.g., CourtAlert®). As is known, such service organizations obtain and distribute information from the court systems on a regular and periodic basis—typically electronically using File Transfer Protocol (FTP), ASP upload, or other similar methods. As an alternative, information can be obtained from court systems in a partially manually operated system, such as by using an optical character recognition (OCR) process using court provided listings. It may be necessary to verify the information after uploading from the OCR process. Information may also be obtained from the federal court's Public Access to Court Electronic Records (PACER) system, which permits the general public, for a fee, to obtain and view documents that have been filed with the court in certain civil cases.

In addition, many federal courts permit attorneys to file documents with the court electronically using the Case Management/Electronic Case Files (CM/ECF) system and to receive court produced electronic mail notifications of filings made by other parties or the court. The case management system may interface with a conventional electronic mail system to monitor and receive electronic mail notifications from the CM/ECF system. Upon receipt of such an e-mail, the system will determine which case the notice is related to based on identifying information such as the court and docket number. The system then determines if any of the header information, such as identification of parties, attorneys, judge, etc., has been modified and, if so, a record will be created and stored as a court sourced alert of a particular internal type of alert referring to header changes. The case management system will also extract the actual docket text from the incoming ECF message and will create a database record within the docketing database representing another internal type of alert referring to a new docket record. The case management system will further extract any associated document images and link the images to the new docket text. As described below, the new court sourced alerts received from the CM/ECF system, as well as their associated document images, will be displayed to the user at a client site as alerts available for reconciliation with previously entered docket records for the same case.

A court sourced alert may contain a variety of types of information or data elements including date, court docket or case number (index number), case caption, document type (e.g., opinion, judgment, decision, order, memo endorsed, stipulation, other), opinion number, and possible other references and notes.

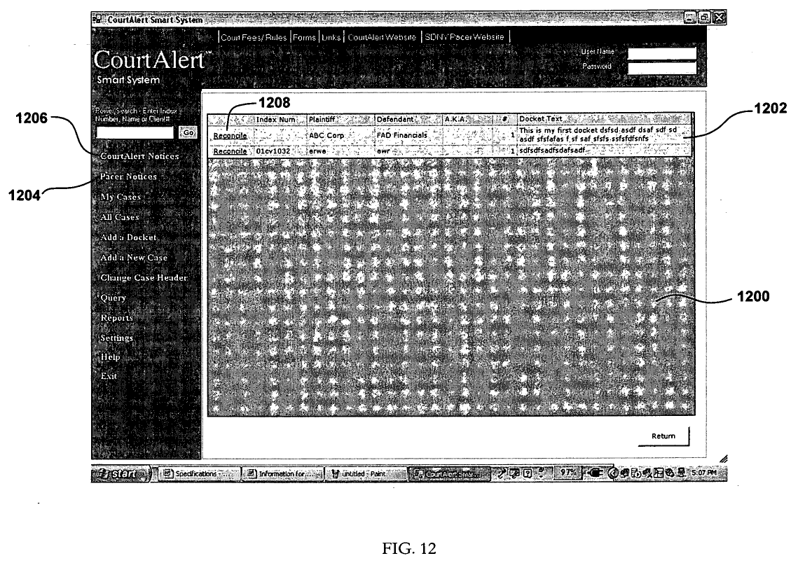

FIGS. 12-15 are a set of screen captures of pages of the case management system illustrating the reconciliation feature of the present invention. Reconciliation is the process of connecting, linking or associating court sourced alert information with pre-existing docket records. In other words, the process of reconciliation links together the existing docket records created when a document is created by the user or when a document is served upon the user with information received from the court. For example, a user may use the reconciliation feature to verify that a document (e.g., a motion) she previously prepared and filed with a court has indeed been received and entered by the court. Thus, the user will be able to reconcile the user docket record created when the document was prepared and filed with the information received from the court that indicates that the document was received and entered by the court system. Based on the reconciled information, the user may be able to then update the pre-existing docket record (for example, by including the date that the document was received by the court in the record), send the updated docket to members of staff and others, and create new diary entries.

As illustrated in FIG. 12, when a user selects the reconciliation display option for the case management system 10 (for example, by selecting either PACER/CM notices option 1204 or CourtAlert® (i.e., service provider) notices option 1206), a reconciliation screen 1200 is provided, which lists all of the court sourced alerts 1202 available for reconciliation. Court sourced alerts 1202 may arrive at the host server 12 and be available for processing in a number of ways. For example, a service provider may convey the information to the host server 12 and its database as part of a file transfer in connection with the e-mail alerts sent directly to the users. In addition, the system may trap e-mail notifications from the case management/electronic case file (CM/ECF) system of the federal court system (and other similar systems). The alerts may also be derived from information retained by the system when the user uses the system to file documents electronically (e.g., using CM/ECF). Furthermore, the alerts may be generated from information retained as part of a PACER watch service. These processes are further discussed below. The information gathered from these various sources is used to produce and display the list of alerts 1202. The alerts may be stored within the case management system 10 by court venue, case identifier, type of alert, etc.

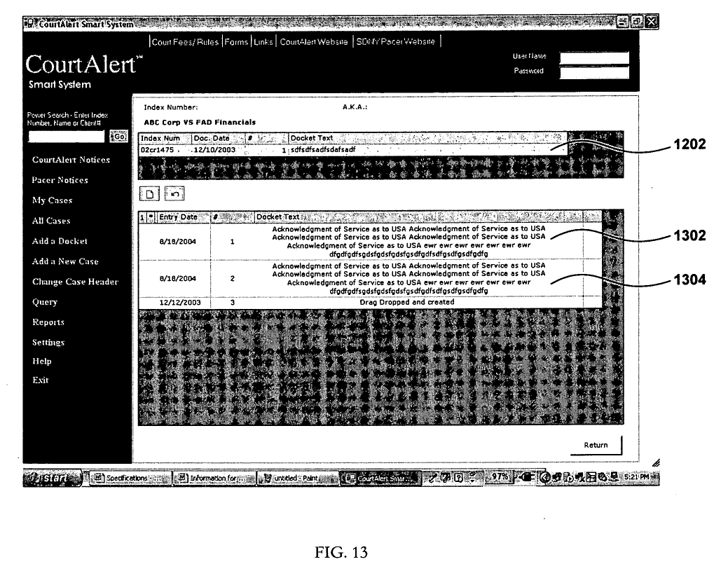

The alerts 1202 may be displayed on separate reconciliation screens, depending on whether the user selected alerts from a service provider or alerts from PACER or CM/ECF systems. The alerts may be color coded to indicate their source, for example as to whether they originated from a service provider, from the PACER system, or from another similar system. The alerts 1202 available for reconciliation may include certain information such as the case name, number or other identifying information, the type of the alert, and the date and time the alert was received, as well as information received from the court. The reconciliation screen 1200 may include an option to view the actual alert notice, which, when selected displays the content of the alert in a fashion similar to the initial receipt of the alert by electronic mail. The user may select one of the alerts 1202 by preferably placing the cursor over the alert 1202 and clicking on the mouse or by using a number of other conventional selection measures. The user may click on or otherwise activate the reconcile option 1208 as discussed above. As shown in FIG. 13, the docket records 1302 for the applicable case (i.e., the one associated with the selected alert 1202) are then displayed in an adjacent new window 1304.

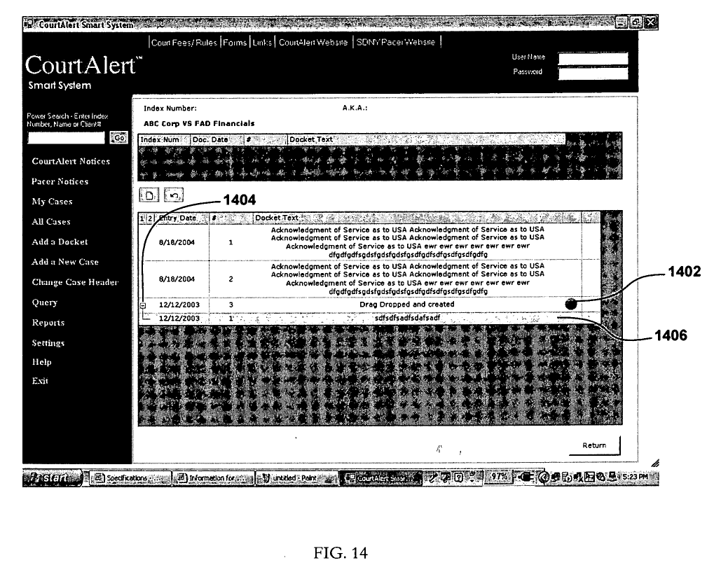

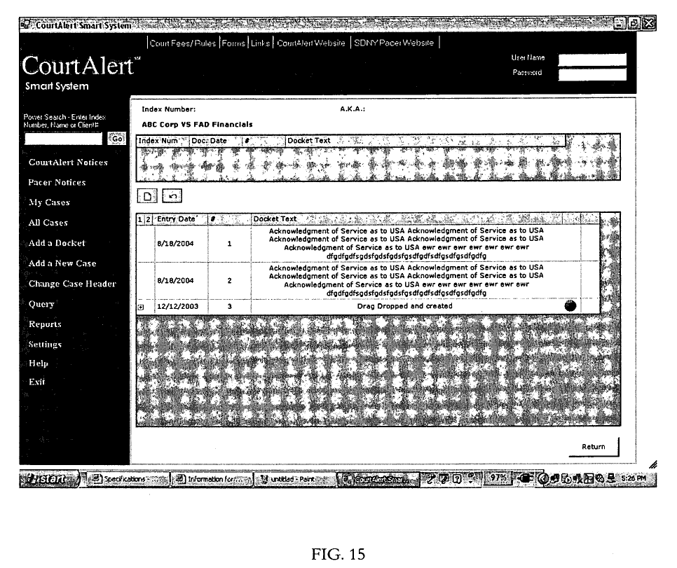

FIG. 14 illustrates one means for reconciling an alert 1202 with a previously entered docket record 1302. The user selects an alert 1202, drags the box containing the alert into the window 1304 containing the docket records for this legal case, and drops the alert box onto the applicable docket record. For example, an alert which confirms that a previously filed motion was received by the court may be reconciled with a docket record created by the user when the motion was initially prepared and filed. The case management system then creates an association between the docket record and the court sourced alert. Both the docket record and the court sourced alert are then accessible by court venue, case identifier, and computer assigned docket sequence number, as well as in other methods. A number of other means to initiate the reconciliation process may be employed. The reconciliation screen may indicate that the reconciliation process has occurred by including a reconciliation symbol 1402 adjacent to or in the information box containing the docket record. The symbol 1402 may be coded (e.g., in color) to indicate whether the docket record was reconciled with a court sourced alert that originated from an alert notice from a service organization, from the PACER or ECF Interface. The reconciled alert may then be displayed in a box 1406 near or adjacent to the associated docket record as illustrated in FIG. 14. An expansion symbol 1404 (for example the “−”sign) may indicated that the docket record is associated with a displayed alert. Selection of this expansion symbol 1404 may cause the displayed alert to be concealed from display as illustrated in FIG. 15. The concealed court sourced alert information may be retrieved by selecting an option, for example, the “+” sign adjacent to the record as illustrated in FIG. 15. The reconciliation symbol 1402 remains when the applicable court sourced alert is concealed to allow the user to see at a glance the reconciled user dockets and to which court sourced alert they were reconciled. Once revealed, the court sourced alert information may again be hidden by selecting another option (the “−” sign) to hide the information behind the docket record. Preferably, the reconciliation screen provides an option to “undo” the reconciliation process. In addition, court sourced alerts that have been reconciled are automatically removed from the top part of this reconciliation screen. A counter of unreconciled court sourced alerts may be included to indicate to the user how many court sourced alerts have yet to be reconciled with a previously entered docket record.

Based on a court sourced alert, a user can create a new docket record, as discussed above in connection with FIGS. 7-10. If the user creates a new docket record based on a court sourced alert, the resulting docket is automatically reconciled with the court sourced alert.

Based on the reconciled docket record, a user can create a new diary entry, which may include one or more assignments with applicable due dates, and which may be assigned to particular case team members. In addition, the user can use the information contained in the reconciled docket record to create an electronic mail message to members of the case team, which message may contain information from the reconciled docket record or the new diary entry.

As discussed above, a court sourced alert may be generated from a number of sources. The alert may be generated from manual or electronic monitoring of the court's records. The alert may then be automatically placed in the docketing database for display to the user. The alert may also be generated based upon information retrieved from the PACER system. The court sourced alert derived from the PACER system may include as an attachment an image of the related pleading, for example in a .pdf format file. In addition, the alert may be generated by trapping e-mail messages from the courts' electronic filing systems. Upon receipt of a court sourced alert, the case management system attempts to deduct the legal event from the data contained within the alert. For example, the system may include a deduction process to determine what, if any, court information has changed—the type and form of the legal event represented by the information received from the court system. Using the New York State Supreme Court system as an example, if the “MTN” data table contains a valid and new value for a data element referred to as. “Order Date,” and the data element referred to as “Decision Date” has the same value, then the deduction process determines that a Short Form Order, which was signed by the Judge, has been entered into the court's computer. If the Order Date has a valid and new value, but the Decision Date field is blank, the deduction process determines that a Settle/Submit instruction was issued by the Court and entered into the court's computer system. Alternatively, if the Order Date field has a valid value and the Decision Date field has a valid and new value that is different from the Order Date, the deduction process determines that a Settle/Submit final order was issued by the court and entered into the court's computer system. These are but a few examples. As is known, there are many deductible events and the design of an appropriate deduction process requires knowledge of the court workflow, the workflow at law firms and large legal departments, and details of the particular court's computer systems. With this knowledge, one skilled in the art can readily create a deduction process applicable to the appropriate circumstances. A court sourced alert may also be generated from an independent watch service, which provides information to the case management system 10 electronically. The source of each court sourced alert may be color coded on the display screens.

The case management system may also include a production module that uses data from the court's computer system and databases within the case management system to generate e-mail notifications to subscribers with information related to the court event, in which such notifications contain relevant information such as modified user dockets (modified with information from the court sourced alerts) and diary notifications. The production module also generates information to store in one or more fields within a produced alert database table containing the information used to produced the alert.

The produced alert database table may also be used to provide information on a web site hosted by the service provider for access by users of the case management system. In addition, the produced alert database table may be electronically transmitted to users via FTP, ASP Upload or another suitable process. A user, for example a paralegal within a large law firm, may then use the electronically transmitted information with the case management system to update docket records and perform the reconciliation process.

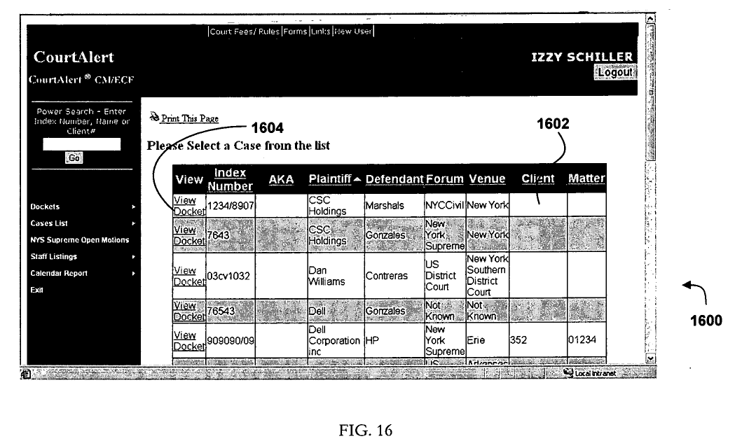

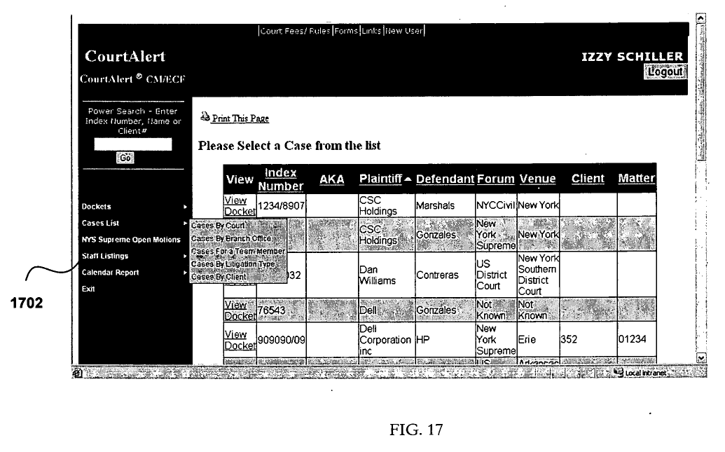

FIGS. 16-17 illustrate an inquiry function available through the case management system 10. The query screen 1600 illustrated in FIGS. 16-17 may be provided upon selection of the query button or icon displayed on the side bar 202 of the initial page 200. The query screen 1600 provides a table 1602 of information regarding each docketed case including an index number, plaintiff, defendant, forum, venue, client and matter reference numbers, and the like. The table 1602 may allow a user to call up dockets for a particular case by accessing one of the view dockets link 1604. As shown in FIG. 17, the query screen 1600 may include a side bar 1702, which allows the user to tailor the presentation of information in the table 1602. For example, selection of the Cases List icon on the side bar 1701 provides a menu 1704 that allows the user to select presentation of cases by various options such as court, office, team member, litigation type or client. Additional options available through the side bar 1702 may include a calendar report to view previously entered diary entries in monthly or agenda formats. The user can utilize the inquiry program from any user client site 20 connected directly or remotely via the Internet. No special program needs to be installed on the inquiring user's computer. The program will work from any standard Internet browser such as Microsoft® Explorer or Netscape.®

The case management system 10 may also include an online inquiry into the PACER system. For example, at a client site 20, the user may key in a venue and case index number. The system at the client site may then log onto the PACER system (using appropriate user id and password), retrieve the case information, and display such information to the user in a manner more convenient to the user than the standard PACER format. The inquiry program may include scanned documents filed with the court. The user can e-mail the last or all dockets from PACER, and include the retrieved document images.

In a similar fashion, the case management system 10 may also include the ability to file documents electronically using CM/ECF. For example, a user may create a docket record, attach a file to such record (e.g., a .pdf version of a pleading), and initiate a transfer of the file to the appropriate court through the use of CM/ECF system. In order to accomplish this function, the user will provide the system with his/her ECF username and password. Once the electronic file transaction is complete, the CM/ECF will confirm the transaction online in the conventional manner. The system will trap this confirmation information and use it as if it were a reconciled CM/ECF or PACER alert. The user docket previously created will be reconciled with this created alert and the staff team will receive notification with the confirmed docket. In addition to filing with the federal court systems, the system may also include means for interfacing with state court systems having electronic filing schemes.

The case management system 10 may also include a module for providing further information to users based upon newly created dockets. For example, when a new docket record is entered into the system, the system may automatically propose one or more diary entries, each with a future task and due date. The user will be provided with the ability to accept the proposed diaries and, if accepted, the system will then produce reminder notifications based upon the calculated due dates. The case management system may also display a list of rule(s) that it used to calculate the new task due dates. The user may then select a displayed rule, and the system will display the actual text of the rule. The rules may be displayed in a three-part window that includes portion for the text of the rule (e.g., from the Federal Rules of Civil Procedure, the Federal Rules of Appellate Procedure or the Bankruptcy Code), a portion for local court rules related to the main rule, and a portion to display any local judge rules or reminders. The system may also link the user to another website containing further information regarding the rule(s). In addition, the system may display a check list of proposed actions to be taken by the user/staff. The users may be able to modify the check lists in order to customize them for their specific law firm. These features may be implemented by providing a smart option as part of the system. Selection of this option for a particular docket record will display the proposed diary entries, the underlying rules, checklists and, if applicable, fill-in forms applicable to the document specified in the docket record.

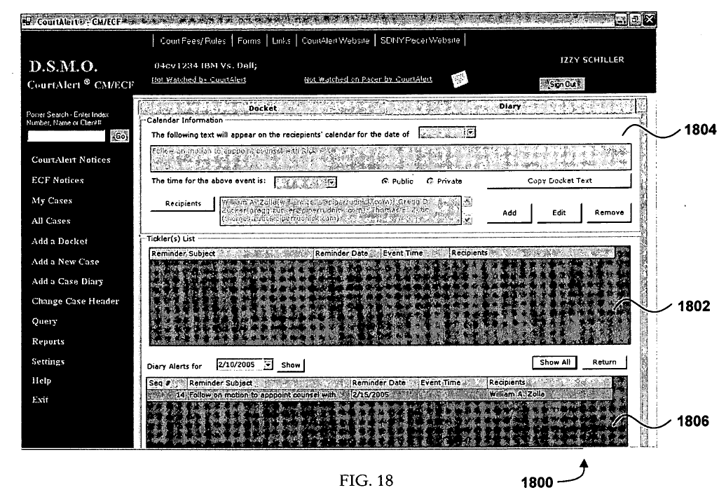

In order to provide this functional module, the system 10 may provide a diary screen 1800 as illustrated in FIG. 18. The diary screen 1800 may be provided when the user enters a new docket record. The diary screen 1800 has three components. The middle window 1802 of the diary screen 1800 includes proposed diaries related to the new docket record. Selection of one of the proposed diary entries in the middle window 1802 causes the proposed diary entry to be moved into the top window 1804. In the top window 1804, the user may modify the proposed diary entry, for example by altering the date of the entry, the list of recipients and the textual information associated with the diary entry. In the top window 1804, the user may then elect to add the new diary entry, which then causes the diary entry to be added to the list of diary entries shown in bottom window 1806.

The case management system 10 provides these tips or smart features, i.e., the ability to display rules and proposed diary entries, based on docket records. For example, as each docket record is associated with a legal document, the rules regarding the filing of the document are known. A database may be created which includes records for each type of legal document (for example, a motion to dismiss a complaint) and entries for the rules associated with each type of legal document. The records within the database for a type of legal document may be further organized into groups and sub-groups so that certain legal documents associated with the same or similar legal rules may be associated and updated at the same time. The database may further include records for each type of legal document to support the proposed diary function. The entries within this database further include a due date, a text for the diary entry, and a formula for calculating the associated dates. For example, the formula would include the rule for calculating when a response to a filing is due based on the service date, the filing date, and the form of service (i.e., mail or in-person).

Although the invention has been described with reference to a specific embodiment, as will be understood by those skilled in the art, other embodiments and variations may be made without departing from the spirit or scope of the invention. In addition, although the invention was described as a method and system for monitoring pending litigation cases, the invention is also useful in other fields and industries. For example, the method and system may be applicable to the pharmaceutical industry to support the integration and reconciliation of information from dispensed prescription medication databases. In addition, the system and method may be used to track the status of various governmental regulatory applications, such as for example clearing aviation plans with the Federal Aviation Association.

I claim:

1. A method for docketing and reporting activities related to a legal case comprising the steps of:
establishing a database in a computer memory for storing case data comprised of a plurality of docket records associated with the legal case;
populating the database with at least one docket record;
receiving a court sourced alert associated with the legal case via a communications network;
loading the court sourced alert into the database;
generating and displaying a docket report listing and identifying the at least one docket record and the court sourced alert;
reconciling the court sourced alert with the docket record; and
modifying the displayed docket report listing to indicate that the court sourced alert has been reconciled with the docket record.

2. The method of claim 1, wherein the step of generating and displaying a docket report further comprises the step of concealing from display those court sourced alerts that have been reconciled with docket records.

3. The method of claim 2, further comprising the step of providing a graphical icon to indicate that one or more of the court sourced alerts have been concealed.

4. The method of claim 1, wherein the step of reconciling comprises the step of creating an association between a court sourced alert and the docket record.

5. The method of claim 1, further comprising the step of updating the docket record with information contained in the court sourced alert.

6. The method of claim 5, further comprising the step of notifying users when a docket record has been updated.

7. The method of claim 6, wherein the step of notifying users comprises the step of distributing an e-mail notification containing information regarding the updated docket record.

8. The method of claim 5, further comprising the step of periodically transmitting at least one reminder to a user based on the updated docket record.

9. The method of claim 5, further comprising the step of generating a diary entry based on the information contained in the updated docket record.

10. The method of claim 9, further comprising the step of periodically notifying users of the generated diary entry.

11. The method of claim 9, further comprising the step of proposing suggested diary entries to the users for selection.

12. The method of claim 11, further comprising the step of providing the users with the text of an underlying legal rule upon which the suggested diary entries are based.

13. The method of claim 1, wherein the step of generating and displaying a docket report further comprises the step of generating and displaying a docket report that identifies those court sourced alerts that remain unreconciled with any docket records.

14. The method of claim 1, wherein the court sourced alerts are derived from court records.

15. The method of claim 1, wherein the court sourced alerts are derived from an electronic filing system associated with a court.

16. The method of claim 15, wherein the court sourced alerts are derived from the electronic filing system by trapping incoming e-mails distributed from the electronic filing system.

17. The method of claim 15, further comprising the step of linking an electronic document to the court sourced alert derived from the electronic filing system.

18. The method of claim 17, wherein the court sourced alert derived from the electronic filing system comprises an indication that there is a change in case header information associated with the legal case.

19. The method of claim 1, further comprising the step of creating a new docket record based on information contained in the court sourced alert.

20. The method of claim 1, further comprising the step of transmitting to the user an indication that the reconciliation is permitted or prohibited.

22. The method of claim 1, wherein the database is comprised of a plurality of docket records associated with a plurality of legal cases, the method further comprising the step of displaying a table of information on each case.

23. The method of claim 22, wherein the step of displaying the table further comprises the step of tailoring the presentation of information in the table.

24. The method of claim 1, further comprising the steps of retrieving information from an electronic filing system associated with a court, reformatting the retrieved information, and presenting the reformatted information.

25. A method for docketing and reporting activities related to a legal case comprising the steps of:
creating a legal document;
filing the legal document with a court;
generating and storing a docket record within a database in a computer memory based on the filing of the legal document with the court;
receiving a court sourced alert via a communications network indicating that the filed legal document has been received by the court;
loading the court sourced alert into the database;
generating and displaying a docket report listing and identifying the docket record and the court sourced alert;
reconciling the docket record with the court sourced alert; and
modifying the displayed docket report listing to indicate that the court sourced alert has been reconciled with the docket record.

26. A method for docketing and reporting activities related to a legal case comprising the steps of:
creating a legal document;
generating and storing a docket record within a database in a computer memory based on the legal document;
electronically filing the legal document with a court;
receiving a court sourced alert via a communications network indicating that the filed legal document has been received by the court;
loading the court sourced alert into the database;
generating and displaying a docket report listing and identifying the docket record and the court sourced alert;
reconciling the docket record with the court sourced alert; and
modifying the displayed docket report listing to indicate that the court sourced alert has been reconciled with the docket record.

27. A method for docketing and reporting activities related to a legal case comprising the steps of:
establishing a database in a computer memory for storing case data comprised of a plurality of docket records associated with the legal case;
populating the database with at least one new docket record;
generating and displaying a docket report listing and identifying the at least one new docket record;
displaying at least one proposed diary entry based on the new docket record;
allowing a user to accept the proposed diary entry; and
if the diary entry is accepted, updating the database to include the new diary entry.

28. The method of claim 27, further comprising the step of periodically notifying users of the new diary entry.

29. The method of claim 27; further comprising the step of providing the users with the text of an underlying legal rule upon which the proposed diary entry is based.

30. The method of claim 27, further comprising the step of generating and displaying a check list of additionally proposed actions.

31. A computer readable medium storing computer instructions for a method for docketing and reporting activities related to a legal case, the method comprising the steps of:
establishing a database in a computer memory for storing case data comprised of a plurality of docket records associated with the legal case;
populating the database with at least one docket record;
receiving a court sourced alert associated with the legal case via a communications network;
loading the court sourced alert into the database;
generating and displaying a docket report listing and identifying the at least one docket record and the court sourced alert;
reconciling the court sourced alert with the docket record; and
modifying the displayed docket report listing to indicate that the court sourced alert has been reconciled with the docket record.

32. A case management system for docketing and reporting activities related to a legal case comprising:
a host server housing a database in a computer memory for storing case data comprised of a plurality of docket records associated with the legal case;
a user client having an input device for populating the database with one or more docket records;
one or more processors associated with the host server and the user client, the processors programmed to perform the following steps:
receive a court sourced alert associated with the legal case via a communications network;
load the court sourced alert into the database;
generate and displaying a docket report listing and identifying the at least one docket record and the court sourced alert;
reconcile the court sourced alert with the docket record; and
modify the displayed docket report listing to indicate that the court sourced alert has been reconciled with the docket record.
